(19) United States
(12) Patent Application Publication
(10) Pub. No.: US 2012/0169405 A1
(43) Pub. Date: Jul. 5, 2012

(54) METHOD AND APPARATUS FOR GENERATING VOLTAGE

(76) Inventor: Won-Beom CHOI, Gyeonggi-do (KR)

(21) Appl. No.: 13/180,855

(22) Filed: Jul. 12, 2011

(30) Foreign Application Priority Data
Jan. 3, 2011 (KR) 10-2011-0000138

(51) Int. Cl. G05F 1/10

(52) U.S. Cl. 327/536

(57) ABSTRACT

An apparatus for generating an output voltage includes a boosting circuit configured to generate the output voltage by boosting an input voltage based on a boosting rate, and a pump level controller configured to control the boosting rate in response to the input voltage.

### CROSS-REFERENCE TO RELATED APPLICATIONS

The present application claims priority of Korean Patent Application No. 10-2011-0000138, filed on Jan. 3, 2011, which is incorporated herein by reference in its entirety.

### BACKGROUND OF THE INVENTION

Exemplary embodiments of the present invention relate to a method for generating voltage, and more particularly, to a method and apparatus for generating a boosting voltage to be supplied to an integrated circuit.

An integrated circuit includes internal circuits using a higher voltage than an external voltage supplied from the outside. A word line driving circuit for driving word lines inside a Dynamic Random Access Memory (DRAM) device is an example of an internal circuit using a higher voltage than an external voltage. Therefore, an integrated circuit may further include a boosting circuit to generate a higher voltage than an external voltage by using an input voltage supplied from the outside.

A representative example of a boosting circuit is a charge pump circuit including a pump unit which is formed by serially coupling one diode-type transistor with one capacitor. Since a charge pump circuit has a relative simple structure, it is often used in the field of integrated circuits.

Each pump unit of a charge pump circuit may boost a voltage by a predetermined amount and a plurality of pump units may be used to acquire a desired amount of boosting voltage. In short, as the number of pump units included in a charge pump circuit increases, the boosting voltage generated by the charge pump circuit becomes higher. On the other hand, as the number of pump units increases, the efficiency of the charge pump circuit decreases. Therefore, a method has been developed for increasing the efficiency of a charge pump circuit while generating a desired boosting voltage.

### SUMMARY OF THE INVENTION

An embodiment of the present invention is directed to a method and apparatus for efficiently controlling a charge pump circuit in consideration of the level of an input voltage and a boosting voltage to be generated.

In accordance with an exemplary embodiment of the present invention, an apparatus for generating an output voltage includes: a boosting circuit configured to generate the output voltage by boosting an input voltage based on a boosting rate; and a pump level controller configured to control the boosting rate in response to the input voltage.

In accordance with another exemplary embodiment of the present invention, an apparatus for generating a voltage includes: a first boosting circuit configured to generate a first boosting voltage by boosting an input voltage based on a boosting rate; a second boosting circuit configured to generate a second boosting voltage by additionally boosting the first boosting voltage in response to an enabling signal; a pump level controller configured to generate the enabling signal based on a comparison result between the input voltage and a first reference voltage; and a pump controller configured to control operations of the first boosting circuit and the second boosting circuit in response to the first and second boosting voltages.

### BRIEF DESCRIPTION OF THE DRAWINGS

FIG. 1 is a block diagram illustrating a structure of a conventional boosting circuit.

FIG. 2 is a circuit diagram illustrating a circuit structure of a pump controller 114 shown in FIG. 1.

FIG. 3 is a block diagram illustrating a structure of a voltage generation apparatus in accordance with an embodiment of the present invention.

FIG. 4 is a circuit diagram illustrating a structure of a pump level controller 314 shown in FIG. 3.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

FIG. 1 is a block diagram illustrating a structure of a conventional boosting circuit.

Referring to FIG. 1, the boosting circuit includes a charge pump 112 and a pump controller 114.

The charge pump 112 generates a boosting voltage V_PUMP by boosting an input voltage V_CC with a plurality of pump units 102 to 110. The pump units 102 to 110 may be realized in the forms of diverse well-known pump circuits, such as Dickson charge pumps, four-phase charge pump, cross-coupled charge pump and the like.

The pump controller 114 controls the operation of the charge pump 112 based on the level of the boosting voltage V_PUMP generated by the charge pump 112. In short, the pump controller 114 generates an oscillation signal OSC and controls the pump operation of the charge pump 112 to continue when the boosting voltage V_PUMP generated by the charge pump 112 is lower than a reference voltage V_EN.

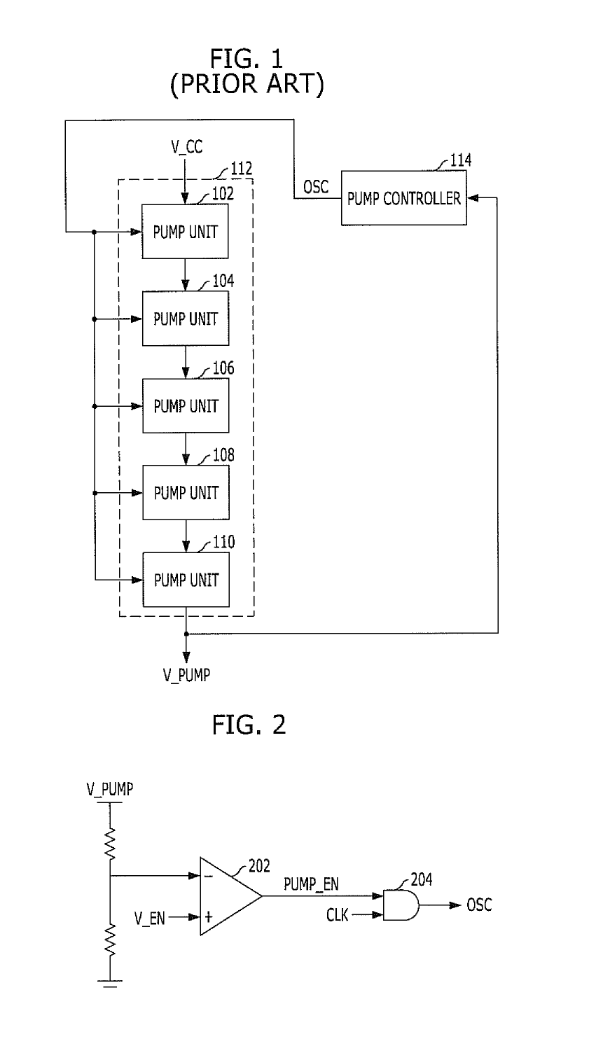

FIG. 2 is a circuit diagram illustrating a circuit structure of a pump controller 114 shown in FIG. 1.

Referring to FIG. 2, the boosting voltage V_PUMP inputted to the pump controller 114 is divided by using two resistors that are coupled with each other in series. The divided boosting voltage obtained from the division is inputted to a comparison unit 202.

The comparison unit 202 compares the divided boosting voltage with the reference voltage V_EN. When a divided boosting voltage is lower than the reference voltage V_EN, the comparison unit 202 outputs an enabling signal PUMP_EN. When the enabling signal PUMP_EN is inputted, a clock driving unit 204 generates an oscillation signal OSC based on a reference clock CLK. The generated oscillation signal OSC is inputted to the charge pump 112 to operate the charge pump 112.

Referring back to FIG. 1, the voltage boosting principle of a typical charge pump is described. For example, as shown in FIG. 1, when the charge pump 112 includes five pump units 102 to 110, the i^{th} pump unit pumps an output voltage of the (i−1)^{th} pump unit. Whenever an output voltage passes one pump unit, it becomes greater as much as an input voltage V_CC supplied to each pump unit theoretically. Therefore, an input voltage V_CC inputted to a charge pump including n pump units is generally boosted to a voltage of (n+1)×V_CC. In short, as the number of pump units included by a charge pump increases, the level of a generated boosting voltage becomes greater.

However, due to a body effect and/or pumping loss occurring in each pump unit, the actual level of the boosting voltage appears lower than the level of (n+1)×V_DD. Such a loss in the boosting voltage increases as the number of pump units increases. In other words, as the number of pump units included by a charge pump increases, the efficiency of the charge pump decreases.

As described above, the range of the input voltage V_CC may be different according to a boosting voltage V_PUMP to be generated in an integrated circuit using the charge pump which includes a plurality of pump units.

According to an example, the boosting voltage to be generated is approximately 28V and an integrated circuit having a range of the input voltage from approximately 2.7 to approximately 3.6V uses a boosting circuit including 10 pump units. When an input voltage V_CC of approximately 2.7V is inputted, the boosting circuit may generate a boosting voltage of approximately (10+1)×2.7=29.7V.

When an input voltage of approximately 3.6V is inputted to the boosting circuit, the boosting circuit may generate a boosting voltage of approximately (10+1)×3.6=39.6V. This may be greater than the desired level of boosting voltage. In this case, the integrated circuit consumes much current due to excessive use of pump units. Therefore, if seven of ten pump units are used when the input voltage is approximately 3.6V, a boosting voltage of approximately (7+1)×3.6=28.8V may be acquired while the efficiency of the charge pump is increased.

The embodiment of the present invention pays attention to this aspect and provides a voltage generation method and apparatus that may increase the efficiency of a boosting circuit while acquiring a desired boosting voltage by controlling a boosting rate of the boosting circuit based on the level of an input voltage.

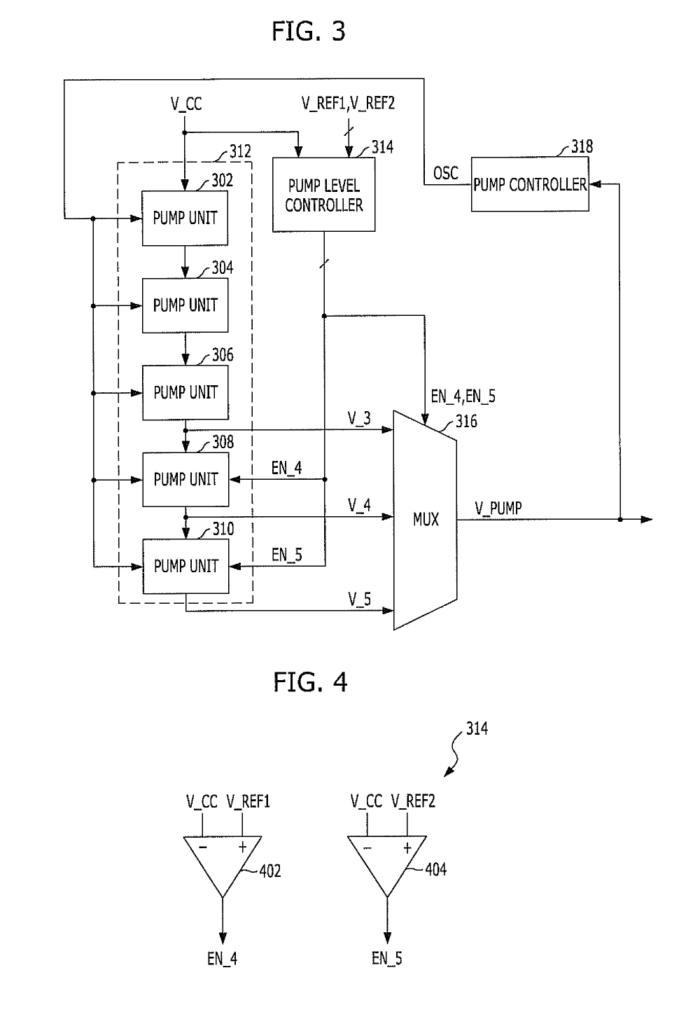

FIG. 3 is a block diagram illustrating a structure of a voltage generation apparatus in accordance with an embodiment of the present invention.

Referring to FIG. 3, a voltage generation apparatus in accordance with the embodiment of the present invention includes a charge pump 312, a pump level controller 314, a multiplexer 316, and a pump controller 318.

The charge pump 312 may include one or more pump units. In this embodiment of the present invention, the charge pump 312 includes five pump units, which are first to fifth pump units 302 to 310.

The operations of the charge pump 312 and the pump controller 318 shown in FIG. 3 are similar to those of the charge pump 112 and the pump controller 114 described with reference to FIGS. 1 and 2. In short, the charge pump 312 generates a boosting voltage V_PUMP by boosting an input voltage V_CC, and the pump controller 318 controls the operation of the charge pump 312 based on the level of the boosting voltage V_PUMP generated by the charge pump 312.

The pump level controller 314 controls the boosting rate of the charge pump 312 based on the level of the input voltage V_CC. In this embodiment of the present invention, the pump level controller 314 compares the input voltage V_CC with reference voltages V_REF1 and V_REF2 and generates enabling signals EN_4 and EN_5 based on the comparison result to control the boosting rate of the charge pump 312. The enabling signals EN_4 and EN_5 adjust the boosting rate of the charge pump 312 by controlling the operations of the fourth pump unit 308 and the fifth pump unit 310. The structure of the pump level controller 314 will be described later with reference to FIG. 4.

The multiplexer 316 selects and outputs any one among different boosting voltages which are generated as the pump level controller 314 controls the boosting rate of the charge pump 312. In this embodiment of the present invention, the multiplexer 316 selects one among a boosting voltage V_3 outputted from the third pump unit 306, a boosting voltage V_4 outputted from the fourth pump unit 308, and a boosting voltage V_5 outputted from the fifth pump unit 310 and outputs the selected boosting voltage as a final boosting voltage V_PUMP. Here, the multiplexer 316 may be controlled based on the enabling signals EN_4 and EN_5 generated by the pump level controller 314.

FIG. 4 is a circuit diagram illustrating a structure of a pump level controller 314 shown in FIG. 3.

Referring to FIG. 4, the pump level controller 314 includes two comparison units 402 and 404. This is because the pump level controller 314 controls the fourth pump unit 308 and the fifth pump unit 310 in accordance with an embodiment of the present invention. According to another embodiment of the present invention, the pump level controller 314 may control a different number of pump units than two and accordingly, the number of comparison units included by the pump level controller 314 may be different.

The comparison unit 402 outputs the enabling signal EN_4 when the input voltage V_CC is lower than the reference voltage V_REF1. The comparison unit 404 outputs the enabling signal EN_5 when the input voltage V_CC is lower than the reference voltage V_REF2. Here, the reference voltage V_REF1 is higher than the reference voltage V_REF2.

Hereafter, a method for generating a voltage in accordance with an embodiment of the present invention is described with reference to FIGS. 3 and 4.

The charge pump 312 including five pump units 302 to 310 boosts the input voltage V_CC. Here, the input voltage V_CC may be not a fixed value but a value that varies within a predetermined range. The boosting circuit in accordance with the embodiment of the present invention boosts the input voltage V_CC by using the first pump unit 302, the second pump unit 304, and the third pump unit 306 when the input voltage V_CC is relatively high. When the input voltage V_CC is relatively low, the desired boosting voltage may be acquired by additionally using the fourth pump unit 308 and the fifth pump unit 310 other than the three pump units.

The pump level controller 314 compares the input voltage V_CC with the reference voltages V_REF1 and V_REF2. When the input voltage V_CC is higher than the reference voltages V_REF1 and V_REF2, the input voltage V_CC may be boosted to the desired level with the three pump units 302 to 306. Therefore, the pump level controller 314 does not output an enabling signal. Accordingly, the charge pump 312 generates a boosting voltage V_3 by using the three pump units 302 to 306, and the generated boosting voltage V_3 is selected by the multiplexer 316 and outputted as a final boosting voltage V_PUMP.

When the input voltage V_CC is higher than the reference voltage V_REF2 and lower than the reference voltage V_REF1, the pump level controller 314 outputs the enabling signal EN_4. The enabling signal EN_4 enables the fourth pump unit 308 to operate after the operations of the three pump units 302 to 306, and the charge pump 312 generates a boosting voltage V_4. The boosting voltage V_4 is selected by the multiplexer 316 and outputted as a final boosting voltage V_PUMP.

When the input voltage V_CC is lower than the reference voltages V_REF1 and V_REF2, the pump level controller 314 outputs the enabling signals EN_4 and EN_5. The enabling signals EN_4 and EN_5 enables the fourth pump unit 308 and the fifth pump unit 310 to operate subsequent to operations of the three pump units 302 to 306, and the charge pump 312 generates a boosting voltage V_5. The boosting voltage V_5 is selected by the multiplexer 316 and outputted as a final boosting voltage V_PUMP.

The final boosting voltage V_PUMP outputted from the multiplexer 316 is inputted to the pump controller 318, and the pump controller 318 operates the charge pump 312 until the final boosting voltage V_PUMP reaches the desired voltage value.

According to the embodiment described with reference to FIGS. 3 and 4, the charge pump 312 includes five pump units 302 and 310, and the pump level controller 314 controls the fourth pump unit 308 and the fifth pump unit 310. However, according to another embodiment of the present invention, a number of pump units that are included in the charge pump may not equal five. Also, a number of pump units that are controlled by the pump level controller may not equal two and the circuit structure of the pump level controller may be different from that of FIG. 4.

According to an embodiment of the present invention described above, when an input voltage is boosted using charge pumps, the number of charge pumps to be used may be controlled in consideration of the level of the input voltage and a boosting voltage to be generated.

While the present invention has been described with respect to the specific embodiments, it will be apparent to those skilled in the art that various changes and modifications may be made without departing from the spirit and scope of the invention as defined in the following claims.

What is claimed is:

1. An apparatus for generating an output voltage, comprising:
a boosting circuit configured to generate the output voltage by boosting an input voltage based on a boosting rate; and
a pump level controller configured to control the boosting rate in response to the input voltage.

2. The apparatus of claim 1, wherein the boosting circuit comprises a charge pump comprising a plurality of pump units, and
the pump level controller is configured to control the boosting rate by controlling operation of at least one pump unit of the pump units.

3. The apparatus of claim 2, wherein the pump level controller is configured to adjust the boosting rate by controlling a number of the pump units to be enabled.

4. The apparatus of claim 3, wherein the pump level controller is configured to generate an enabling signal based on a comparison result between the input voltage and a first reference voltage and control the operation of at least one pump unit among the pump units in response to the enabling signal.

5. The apparatus of claim 4, wherein the pump level controller is configured to generate the enabling signal when the input voltage is lower than the first reference voltage.

6. The apparatus of claim 2, wherein the boosting circuit further comprises a pump controller configured to control an operation of the charge pump in response to the output voltage.

7. The apparatus of claim 6, wherein the pump controller is configured to control an operation of the charge pump when the voltage is lower than a first reference voltage.

8. The apparatus of claim 1, wherein the boosting circuit is configured to generate different boosting voltages as the output voltage based on the boosting rate.

9. The apparatus of claim 8, further comprising:
a multiplexer configured to select one of the different boosting voltages and output the selected boosting voltage.

10. The apparatus of claim 9, wherein the multiplexer is controlled in response to an enabling signal generated by the pump level controller in response to comparing of the input voltage with a first reference voltage.

11. An apparatus for generating a voltage, comprising:
a first boosting circuit configured to generate a first boosting voltage by boosting an input voltage based on a boosting rate;
a second boosting circuit configured to generate a second boosting voltage by additionally boosting the first boosting voltage in response to an enabling signal;
a pump level controller configured to generate the enabling signal in response to a comparison result between the input voltage and a first reference voltage; and
a pump controller configured to control operations of the first boosting circuit and the second boosting circuit in response to the first and second boosting voltages.

12. The apparatus of claim 11, wherein each of the first boosting circuit and the second boosting circuit comprises a charge pump having at least one pump unit.

13. The apparatus of claim 11, further comprising:
a multiplexer configured to select one of the first and second boosting voltages in response to the enabling signal and output the selected boosting voltage to the pump controller.
